(19) United States
(12) Patent Application Publication
(10) Pub. No.: US 2008/0130484 A1
(43) Pub. Date: Jun. 5, 2008

(54) TRANSMIT DIVERSITY OF BROADCAST CHANNEL IN OFDMA BASED EVOLVED UTRA

(75) Inventors: Guodong Zhang, Farmingdale, NY (US); Kyle Jung-Lin Pan, Smithtown, NY (US); Robert Lind Olesen, Huntington, NY (US); Allan Yingming Tsai, Boonton, NJ (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/930,440

(22) Filed: Oct. 31, 2007

Related U.S. Application Data
(60) Provisional application No. 60/855,809, filed on Oct. 31, 2006.

(51) Int. Cl. H04J 11/00

(52) U.S. Cl. 370/208; 370/203

(57) ABSTRACT

In a communications system with a wireless transmit/receive unit and a cell, a method for transmission of a broadcast channel is presented. The method contains the steps of generating a broadcast signal, processing said broadcast signal according to a modified spatial frequency block coding scheme, and broadcasting the processed signal to a wireless transmit/receive unit.

### CROSS REFERENCE TO RELATED APPLICATION(S)

This application claims the benefit of U.S. Provisional Patent Application No. 60/855,809, filed Oct. 31, 2006, which is incorporated by reference as if fully set forth.

### FIELD OF INVENTION

The present invention relates to a wireless communication system.

### BACKGROUND

The standards for Universal Terrestrial Radio Access (hereinafter, UTRA) are evolving as the demands made by users of such systems grow in many different areas, including, but not limited to, geography, number of users, and functionality.

Currently, orthogonal frequency division multiple access (OFDMA) is being considered for the downlink of evolved UTRA. Under OFDMA, after a wireless transmit receive unit (WTRU) acquires downlink timing and frequency via cell search, for example, the WTRU reads the broadcast channel (BCH) to obtain cell and system specific information. As those having skill in the art know, there are two types of BCH channels: one is called primary BCH (P-BCH), and the other is called secondary BCH (S-BCH). Transmit diversity scheme for BCH is an important design issue for BCH, since it affects the coverage of the BCH.

At initial access, BCH will be received by the WTRU without a priori knowledge of the number of transmit antennas of the cell. Therefore, a transmit diversity scheme not requiring knowledge of the number of transmit antennas should be applied. Several transmit diversity schemes, such as time switch transmit diversity (TSTD), frequency switch transmit diversity (FSTD), preceding vectors switch (PVS) or hybrid TSTD-FSTD, have been used for BCH transmission.

Conventional Spatial Frequency Block Coding (SFBC) is another transmit diversity scheme that allows for high quality BCH reception. As those having skill in the art know, SFBC directly spreads the Alamoutic code over two subchannels in one OFDM block in an antenna array including two antennas. However, conventional SFBC cannot be directly applied to P-BCH that is transmitted by an antenna array that has more than two antennas.

Therefore, there exists a need for a transmit diversity scheme that operates with an antenna array comprising two or more antennas, and does not require prior knowledge by the WTRU of the number of transmit antennas.

### SUMMARY

This invention is related to the transmit diversity scheme used in the broadcast channel of an evolved UTRA communications system with a wireless transmit/receive unit and a cell. More specifically, the invention is related to the use of a modified spatial frequency block coding as the transmit diversity scheme such that high performance can be achieved while the WTRU has no knowledge of the number of transmit antennas at the cell.

### BRIEF DESCRIPTION OF THE DRAWINGS

FIG. 1 illustrates an example LTE wireless communication system;

FIG. 2 is an example signal diagram of a method using the disclosed modified spatial frequency block coding scheme;

FIG. 3 is an example signal diagram of a spatial frequency block coding scheme;

FIG. 4 is an example illustration of the symbol structure of a single antenna system.

FIG. 5 is an example illustration of the symbol structure of a two antenna system.

FIG. 6 is an example illustration of yet another symbol structure of a two antenna system.

### DETAILED DESCRIPTION

Hereafter, a wireless transmit/receive unit (WTRU) includes but is not limited to a user equipment, mobile station, fixed or mobile subscriber unit, pager, or any other type of device capable of operating in a wireless environment. When referred to hereafter, a base station includes but is not limited to a Node-B, site controller, access point or any other type of interfacing device in a wireless environment.

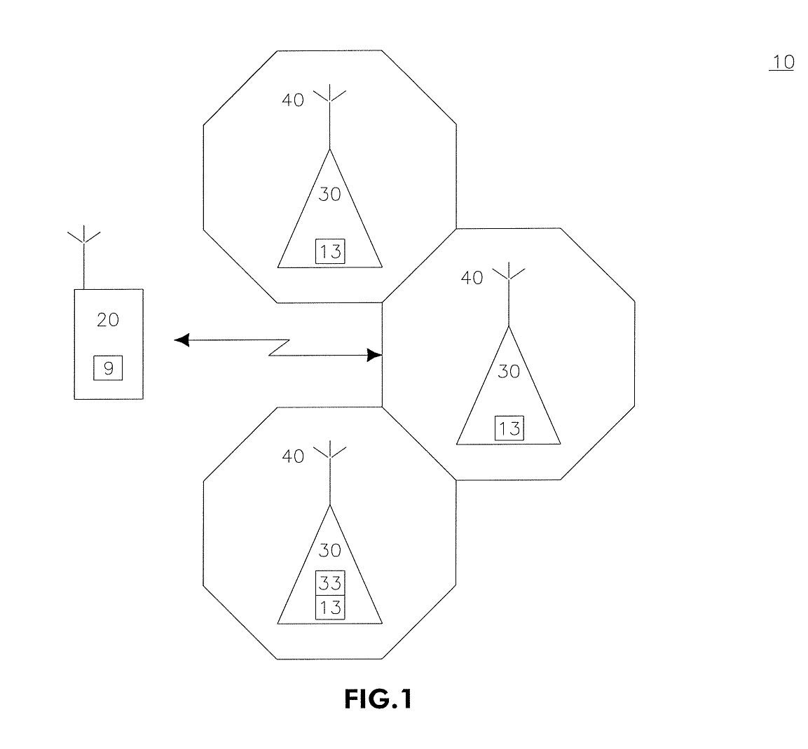

FIG. 1 is an example of LTE wireless communication network having a plurality of Node-Bs and WTRUs. A LTE wireless communication network (NW) 10 comprises a WTRU 20, including a transceiver 9, one or more Node Bs 30, and one or more cells 40. Each NodeB controls one or more cell 40. Each NodeB includes a transceiver 13 and a processor 33 for implementing the method disclosed hereafter, for processing a broadcast channel signal using a disclosed transmit diversity scheme.

Although not illustrated as such, eNB 30 may have 2 or more antennas 128. For eNB 30 with 2 antennas, a 2×2 SFBC scheme can be applied to the transmit symbol as follows:

$$[ \begin{matrix}{S}_{1 , j} & - {S}_{2 , j + 1}^{*} \\ {S}_{2 , j} & {S}_{1 , j + 1}^{*}\end{matrix} ] , \qquad Equation ( 1 )$$

where s_{i,j} is transmit symbol at antenna i and at associated subcarrier j or j+1.

A special case of the conventional SFBC scheme of Equation 1 is equivalent to the frequency switch transmit diversity scheme (FSTD), which may be written as one of the following:

$$[ \begin{matrix}{S}_{1 , j} & 0 \\ 0 & {S}_{2 , j + 1}\end{matrix} ] , [ \begin{matrix}{S}_{2 , j} & 0 \\ 0 & {S}_{1 , j + 1}\end{matrix} ] , \\ [ \begin{matrix}0 & {S}_{1 , j + 1} \\ {S}_{2 , j} & 0\end{matrix} ] or [ \begin{matrix}0 & {S}_{2 , j + 1} \\ {S}_{1 , j} & 0\end{matrix} ] \qquad Equation ( 2 )$$

### As stated above, the conventional SFBC scheme cannot be used for a cell containing more than two transmit antennas because it cannot ensure orthogonality or full diversity rate.

As such, a modified SFBC scheme is disclosed for cells with more than two transmit antennas. An example coding using the disclosed modified SFBC scheme for cells with four (4) transmit antennas may be defined as:

$$[ \begin{matrix}{S}_{1 , j} & - {S}_{2 , j + 1}^{*} & 0 & 0 \\ {S}_{2 , j} & {S}_{1 , j + 1}^{*} & 0 & 0 \\ 0 & 0 & {S}_{3 , j + 2} & - {S}_{4 , j + 3}^{*} \\ 0 & 0 & {S}_{4 , j + 2} & {S}_{3 , j + 3}^{*}\end{matrix} ] . \qquad Equation ( 3 )$$

For a cell with 3 transmit antennas, the modified SFBC scheme can be applied. The proposed transmit coding is given as

$$[ \begin{matrix}{S}_{1 , j} & 0 & 0 \\ 0 & {S}_{2 , j + 1}^{*} & 0 \\ 0 & 0 & {S}_{3 , j + 2}\end{matrix} ] . \qquad Equation ( 4 )$$

In the disclosed modified SFBC, the broadcast channel (BCH) can be received and processed by WTRU 40, without WTRU 40 has no knowledge of the number of transmit antennas.

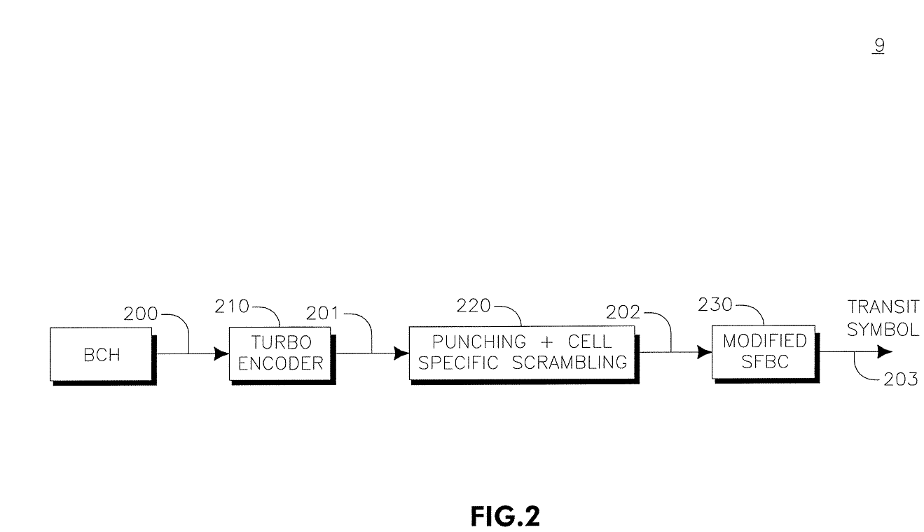

In order to further suppress inter-cell interference on the broadcast channel, turbo encoding and Cell ID specific scrambling coding can be applied to the BCH prior to using modified SFBC transmit diversity coding, as disclosed. Note that with a small number of bits of BCH, convolutional encoding can be used instead of turbo encoding. Illustrated in FIG. 2 is a signal diagram of this method as implemented by processor 9. Processor 9 generates a BCH, as shown in block 200. The BCH 200 is forwarded to a turbo encoder 210 for encoding. The turbo encoded BCH 201 is passed to block 220 where a cell ID specific scrambling and punching is applied at block 220 to the encoded BCH. The scrambled BCH 202 is then forwarded to block 230 where the disclosed modified SBFC is implemented, whereupon transmit symbol 203 is passed to transmitter 12 and transmitted through antenna 128.

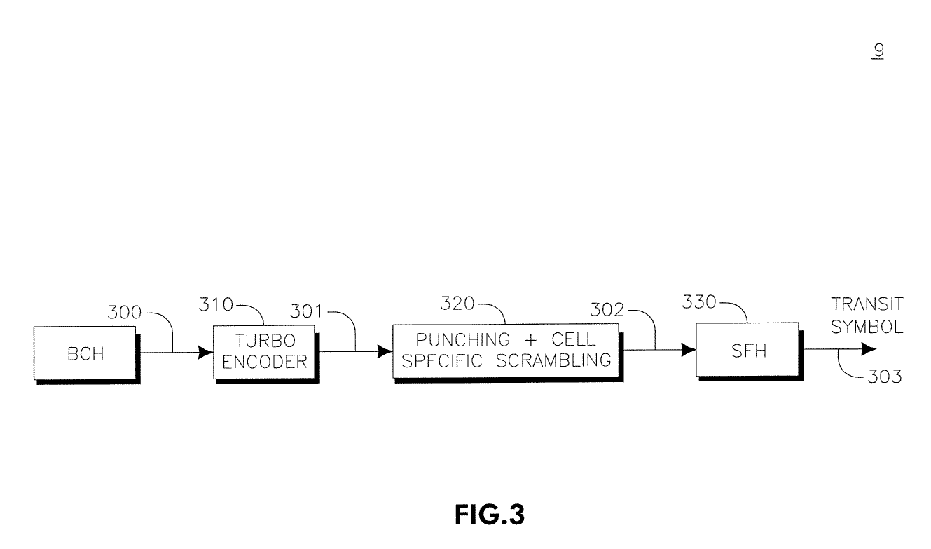

Another transmit diversity scheme is disclosed wherein a space-frequency hopping sequence (SFH) scheme is applied to the BCH. The implementation of the disclosed SFH scheme is preferably used instead of the disclosed SFBC scheme, where a single transmit antenna configuration can be used for P-BCH in addition to multiple antenna configuration at a particular cell. An example signal diagram illustrating a method of BCH transmission using SFH transmit diversity is shown in FIG. 3.

One example method for constructing the primary P-BCH symbols can be expressed as:

S₁={d₁, d₂, . . . d_{K}} Equation (5)

where dᵢ is the transmitted P-BCH symbol data, i=1, . . . , K, and K is the total number of transmitted symbols.

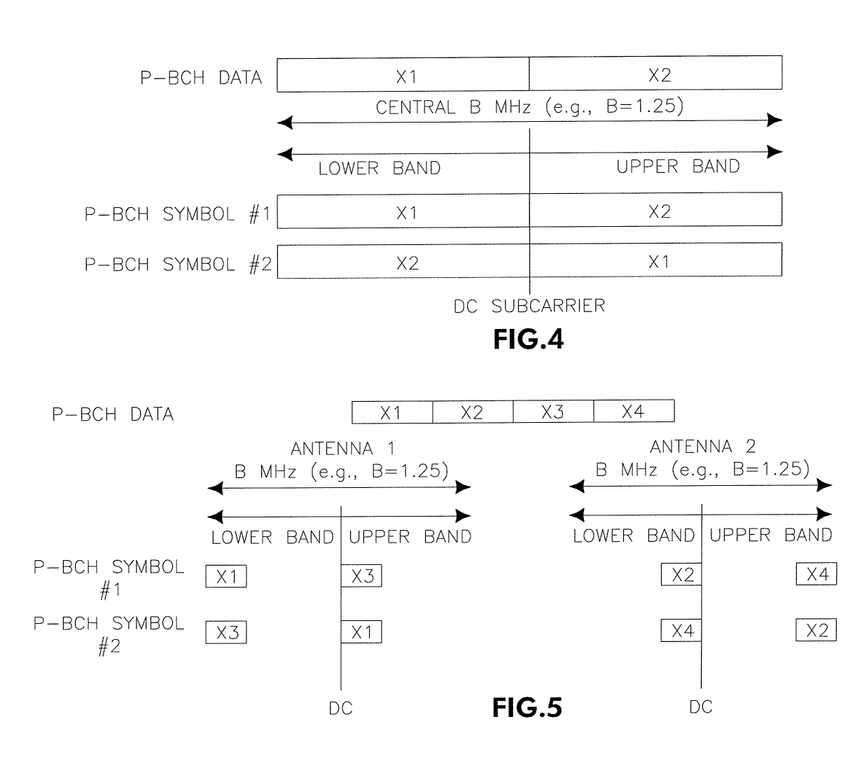

An example P-BCH symbol structure for a cell having one antenna is illustrated in FIG. 4. The P-BCH S₁ can be mapped into a (central) sub-band B (for example, B=1.25 MHz) occupying a total of C subcarriers. The space frequency hopping pattern is constructed by dividing C subcarriers into M (M≧2) groups, each group having Z=C/M subcarriers. The P-BCH data S₁ is also divided into M clusters (x₁, . . . , x_{M}), with xᵢ={d_{(i-1)Z+1}, . . . , d_{iZ}}.

According to the number of transmit antennas in the cell, the number of P-BCH data clusters transmitted per antenna preferably equals Q=M/N_{A}, where N_{A} is the number of transmit antennas for P-BCH. The assignment of data clusters to an antenna will make the distance between data cluster indices transmitted on each antenna equal to N_{A}. For example, clusters {xᵢ, . . . x_{N}_{_{A}}₊ᵢ, . . . } are assigned to antenna Aⱼ, j=1, . . . , N_{A}. Each data cluster xᵢ is transmitted on subcarrier group i.

An example frequency hopping pattern is the index of the subcarrier group occupied by each data cluster hops as follows:

g[n+1]=mod(g[n]+N_{A}, M),

where g[n] is the index of the subcarrier group occupied by a data cluster in the current P-BCH transmission symbol time, is the index of the subcarrier group occupied by the data cluster in the next P-BCH transmission symbol time.

Referring to FIG. 4, the P-BCH data is divided into two clusters, X1 and X2. There are two types of P-BCH symbols. In the first type P-BCH symbol, the P-BCH data block X1 is transmitted in the lower part of the bandwidth of the BCH signal, and the P-BCH data block X2 is transmitted in the upper part of the bandwidth of the BCH signal. The second type of P-BCH symbol is the swapped version of the first type of P-BCH symbol.

FIG. 5 illustrates an example of a two antenna diversity scheme implementing the disclosed SFH scheme disclosed above. As shown in FIG. 5, the P-BCH data is separated into 4 blocks, x1, x2, x3 and x4, the subcarriers are divided into M=4. At antenna 1, in the first P-BCH data symbol, X1 data block is transmitted in the lower part of the transmitted frequency band, while X3 data block is transmitted in the upper part if the band. Meanwhile, at Antenna 2, X2 data block is transmitted at the lower frequency band, while X4 data block is transmitted at the higher frequency band. For the second P-BCH data symbol, the positions of the 4 P-BCH data blocks are swapped.

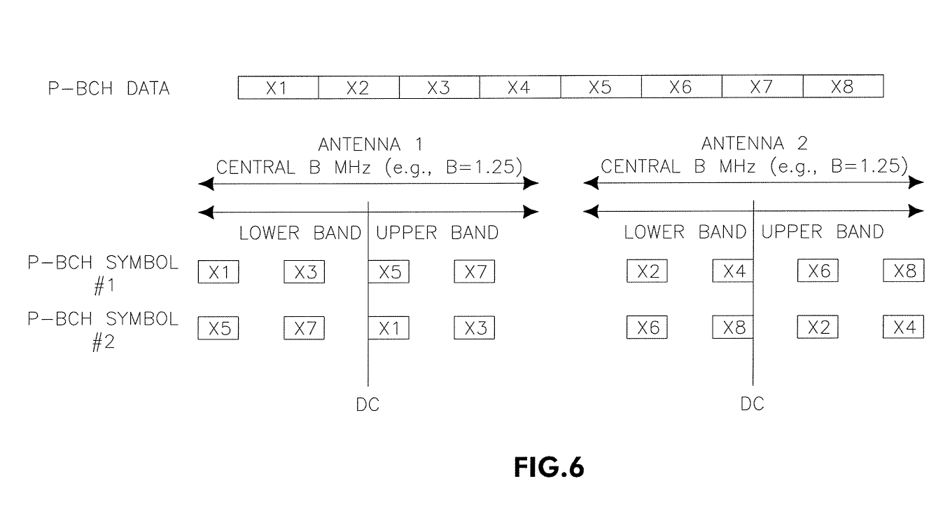

FIG. 6 illustrates the disclosed SFH transmit diversity scheme for 2 antennas and using M=8 partitions. In this case, the P-BCH data is partitioned into 8 (eight) blocks, X1 through X8. At antenna 1, for P-BCH symbol 1, the odd blocks (X1, X3, X5 and X7) are transmitted at antenna 1 and the even blocks (X2, X4, X6 and X8) are transmitted at antenna 2. For P-BCH symbol 1, X1 and X3 are transmitted in the lower frequency band and X5 and X7 are transmitted at the higher frequency band. Similarly, at antenna 2, X2 and X4 are transmitted at the lower frequency band, while X6 and X8 are transmitted at the higher frequency band. For P-BCH symbol 2, the positions of the 8 P-BCH data blocks are swapped.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for transmitting on a broadcast channel comprising:
generating a signal;
processing said signal according to a modified spatial frequency block coding scheme; and
broadcasting the processed signal.

2. The method of claim 1, further comprising encoding the signal prior to processing the signal.

3. The method of claim 2, wherein the encoding step includes the application of Cell ID specific coding of the signal.

4. The method claim 3, wherein the step of encoding includes the application of turbo encoding of the signal.

5. A method for transmitting on a broadcast channel (BCH) comprising:
generating a signal;
processing said signal according to a space-frequency hopping diversity scheme; and
broadcasting the processed signal.

6. The method of claim 5, wherein the space-frequency hopping diversity scheme further comprises the steps of:
dividing C subcarriers into M (M≧2) groups, each group has Z=C/M subcarriers;
dividing a plurality of primary P-BCH data S₁ into M clusters (x₁, . . . , x_{M}), with xᵢ={d_{(i-1)Z+1}, . . . d_{iZ}}; and
transmitting the plurality of P-BCH data according to the equation Q=M/N_{A}, where N_{A} is the number of transmit antennas for the P-BCH data.

7. The method of claim 6, wherein an assignment of data clusters to an antenna will make the distance between data cluster indices on the antenna equal to N_{A}.

8. The method of claim 7, wherein a plurality of data clusters {xᵢ, . . . x_{N}_{_{A}}₊ᵢ, . . . } are assigned to antenna Aⱼ, where j=1, . . . , N_{A}.

9. The method of claim 8, wherein each data cluster xᵢ is transmitted on subcarrier group i.

10. The method of claim 9 wherein each data cluster hops according to the equation:
g[n+1]=mod(g[n]+N_{A}, M),
where g[n] is the index of a subcarrier group occupied by a data cluster in a P-BCH transmission symbol time period, and g[n+1] is an index of a subcarrier group occupied by the data cluster in the next P-BCH transmission symbol time period.

11. The method of claim 10, further comprising processing the broadcast signal using frequency switch transmit diversity.

12. The method of claim 11, further comprising the step of encoding the Broadcast signal prior to processing the signal.

13. The method of claim 12, wherein the encoding step includes the application of Cell ID specific coding of the signal.

14. The method of claim 13, wherein the step of encoding includes the application of turbo encoding of the signal.

15. A Node B comprising:
a processor for processing a signal according to a modified spatial frequency block coding (SFBC) scheme; and
a transmitter for transmitting the processed signal on a broadcast channel.

16. The Node B of claim 15, wherein said processor comprises:
an encoder for encoding said signal prior to processing the signal using said coding scheme.

17. The Node B of claim 16, wherein said encoding includes the application of Cell Id specific scrambling coding.

18. A Node B comprising:
a processor for processing a signal according to a space-frequency hopping (SFH) diversity scheme; and
a transmitter for transmitting the processed signal on a broadcast channel.

19. The Node B of claim 18, wherein the space-frequency hopping diversity scheme comprises:
dividing C subcarriers into M (M≧2) groups, each group has Z=C/M subcarriers;
dividing a plurality of primary P-BCH data S₁ into M clusters (x₁, . . . , x_{M}), with xᵢ={d_{(i-1)Z+1}, . . . , d_{iZ}}; and
transmitting the plurality of P-BCH data according to the equation Q=M/N_{A}, where N_{A} is the number of transmit antennas for the P-BCH data.

20. The Node B of claim 19, wherein an assignment of data clusters to an antenna will make the distance between data cluster indices on the antenna equal to N_{A}.

21. The Node B of claim 20, wherein a plurality of data clusters {xᵢ, . . . x_{N}_{_{A}}₊ᵢ, . . . } are assigned to antenna Aⱼ, where j=1, . . . , N_{A}.

22. The Node B of claim 21, wherein each data cluster xᵢ is transmitted on subcarrier group i.

23. The Node B of claim 22 wherein each data cluster hops according to the equation:
g[n+1]=mod(g[n]+N_{A}, M),
where g[n] is the index of a subcarrier group occupied by a data cluster in a P-BCH transmission symbol time period, and g[n+1] is an index of a subcarrier group occupied by the data cluster in the next P-BCH transmission symbol time period.

24. The Node B of claim 18, wherein said processor comprises:
an encoder for encoding said signal prior to processing the signal using said coding scheme.

25. The Node B of claim 24, wherein said encoding includes the application of Cell Id specific scrambling coding.
